(19) United States
(12) Patent Application Publication
(10) Pub. No.: US 2011/0276799 A1
(43) Pub. Date: Nov. 10, 2011

(54) PERSONAL COMMUNICATION SYSTEM HAVING INDEPENDENT SECURITY COMPONENT

(76) Inventor: Keicy Chung, Torrance, CA (US)

(21) Appl. No.: 13/100,561

(22) Filed: May 4, 2011

Related U.S. Application Data
(60) Provisional application No. 61/332,075, filed on May 6, 2010.

(51) Int. Cl. G06F 12/14; G06F 12/08; H04L 9/00

(52) U.S. Cl. 713/165; 711/163; 711/118; 711/135; 711/E12.092; 711/E12.022

(57) ABSTRACT

A personal communication system (PCS) incorporates a secure storage device, which includes a device processor, a CPU interface, and a system interface, a storage means and a removable storage media component. The device processor is communicably connected to the CPU of the PCS through the CPU interface, which exclusively enables communications between the device processor and the CPU. The system interface enables the device processor to manage one or more hardware components of the PCS. A network interface is also included to enable the device processor to communicate over a network with select file servers to the exclusion of other file servers. The storage means is communicably connected to the device processor and includes first and second designated storage sections. The device processor has read-write access to both storage sections and gives the CPU read-only access to the first storage section and read-write access to the second storage section.

### PRIORITY

Priority is claimed to U.S. provisional patent application No. 61/332,075, filed May 6, 2010, the disclosure of which is incorporated herein by reference in its entirety.

### RELATED APPLICATIONS

The present application is related to U.S. Pat. No. 7,069,351, issued on Jun. 27, 2006, U.S. Pat. No. 7,444,393, issued on Oct. 28, 2008, U.S. patent application Ser. No. 12/113,294, filed on May 1, 2008, and U.S. patent application Ser. No. 12/186,120, filed on Aug. 5, 2008, the disclosures of which are incorporated herein by reference in their entirety.

### BACKGROUND OF THE INVENTION

1. Field of the Invention

The field of the present invention is personal communication systems (hereinafter “PCS”), also commonly known as personal digital assistants (PDA's), smart phones, and hand-held gaming or entertainment devices.

2. Background

A typical personal communication system (PCS), such as a PDA, a smart phone, and a hand-held gaming or entertainment device, has many components integrated together. Some of the common components are CPU, memory for program execution, memory for storing programs and data, microphone, speaker, camera, display, keypad, touchpad, general purpose input/output module (such as a Bluetooth®), environmental sensor, global positioning system (GPS) module, battery/power module, cellular network module, wireless network module, etc., as depicted in U.S. Pat. No. 7,321,783. Depending on the particular use for a PCS, many variations are possible utilizing all or some of these, and other, components.

An operating system (often referred to as “firmware”) is responsible for proper control and operation of all the components of a PCS. Some of the common operating systems used on smart phones, for instance, are Microsoft Windows Mobile®, Google Android®, Palm OS®, Nokia Symbian®, and RIM Blackberry® OS, to name a few. The operating system provides a platform on which applications can access and utilize various components of a PCS to accommodate a wide range of user experience, such as making a phone call, sending and receiving text messages, listening to music, recording voice memos, taking or watching pictures or videos, browsing the Internet, playing games, etc. In fact, the functionalities of PCS's are quite analogous to how personal computers are used today, but PCS's are quite compact and have far less powerful processing power than typical personal computers.

The files used by a PCS's operating system and applications are usually stored in memory, typically in a flash memory embedded in the PCS or in a removable media that extend the capacity of the embedded flash memory. The flash memory or the removable media would essentially look like a local storage device of a personal computer (i.e. a hard disk drive) to the PCS operating system and would have file systems that manage the stored files. The operating system of a PCS uses the file systems to handle file requests from applications or from the operating system itself in a manner quite analogous to how an operating system running on a personal computer handles file requests. Furthermore, the way the operating system of a PCS manages its various components are very similar to how a personal computer manages its various components programmatically. Thus, PCS's have the same kind of security vulnerabilities that personal computers have, such as viruses, malware, unauthorized access, file corruptions due to user errors or application errors, etc. To mitigate the security vulnerabilities a PCS has, the PCS often mimics various methods available to a personal computer.

For instance, a PCS may implement directory-level or file-level access controls to provide certain level of file protection against computer viruses, malware, unauthorized access, file corruptions due to user errors or application errors, etc. The drawback of this method is that this is operating system dependant. Thus, a super user, an administrator, or a process running with full access privileges can accidentally modify, delete, or corrupt important files used by the operating system or applications.

Alternatively, a PCS may use an anti-virus and/or anti-spyware program to deter malicious programs (viruses and spyware) that can inflict detrimental damages to the PCS, especially when such malicious programs gain full access privileges on the PCS. But the use of an anti-virus anti-spyware program on a PCS is quite impractical because, among many other reasons, (a) anti-virus anti-spyware programs are operating system dependent, (b) there are many different operating systems for PCS's, so it is almost impossible to develop anti-virus anti-spyware programs for various brands and models of PCS's, (c) virus/spyware signature files are getting bigger as the number of viruses and spyware are growing, (d) the processors used in most PCS's are not quite powerful enough to perform continuous scan for viruses and spyware, and (e) anti-virus anti-spy programs may have false-positive and erroneously delete or quarantine important files used by the operating system or applications, making PCS's not functional.

In addition, one of the growing concerns in today's wide use of PCS's has to do with data security. Because of their portable sizes, PCS's are often lost or stolen while they hold sensitive data. Anyone who has gained physical access to a PCS can easily access the data stored in the PCS. Many PCS users don't lock their PCS's with passwords. And even if a PCS is locked with a password, there are many ways to rest the password without losing the data stored in the PCS. Some PCS's, such as some smart phone models, have a feature commonly called “remote device wipe” in which a remote command can be sent to a PCS to wipe out the data stored in the PCS. But this “remote device wipe” won't work if the PCS is not connected to the network (i.e. the PCS is in “airplane mode” or the SIM card used by certain cellular carriers is taken out of the PCS).

Thus, a new approach is needed to address the security vulnerabilities inherent to PCS's.

### SUMMARY OF THE INVENTION

The present invention is directed to a PCS. The PCS includes all or some of the common components mentioned previously, such as CPU, memory for program execution, microphone, speaker, camera, display, keypad, touchpad, general purpose input/output module (such as a Bluetooth®), environmental sensor, global positioning system (GPS) module, battery/power module, etc., but memory for storing programs and data, cellular network module, and wireless network module are replaced with a storage device disclosed in the related applications referenced above.

The storage device includes a device processor, a CPU interface, a network interface, and a system interface. The device processor is communicably connected to the CPU of the PCS through a CPU interface. The device processor is also communicably connected to a network through network interface that can be cellular network interface (or satellite network interface) and/or wireless network interface, such as WiFi, WiMAX, etc. The CPU interface enables the device processor to communicate exclusively with the CPU of the PCS. The system interface is configured to enable the device processor to manage one or more hardware components included as part of the PCS. The network interface enables the device processor to communicate over a network with select file servers of a service provider to the exclusion of other file servers. A storage means is communicably connected to the device processor and includes first and second designated storage sections. The device processor has read-write access to both storage sections and controls CPU access to each storage section, giving the CPU read-only access to the first storage section and read-write access to the second storage section. A removable media storage component is also communicably connected to the device processor.

The storage device may be constructed with additional options to improve functionality of the storage device and the PCS with which the storage device is associated. Any of these options may be implemented on their own or in combination.

As one option, the storage device may include an encryption module, with the device processor being adapted to utilize the encryption module for one or more encryption/decryption functions. Such functions may include encrypted communications with the select file servers, encrypted storage of files on the storage means, and encrypted storage of files using the removable media storage component. Encryption keys used by the encryption module may be obtained from one of the select file servers through the network interface of the storage device.

As another option, the device processor may be programmed to follow a series of sequential steps when a request for a file is received from the CPU. First, the device processor determines whether the file is cached within the first designated storage section, and if the file is there, provides the file to the CPU on a read-only basis (without giving the CPU any capability of modifying or deleting the file). Next, if the file is not found cached, the device processor requests the file from one or more of the select file servers. If the file is available from one of the select file servers, the file is retrieved, cached within the first designated storage area, and provided to the CPU on a read-only basis. Lastly, if the file is not otherwise found, a file unavailable notice is returned to the CPU. As an additional step within this sequence, the device processor may be programmed to determine whether the file is available from the removable media storage component if the file is not available from one of the select file servers. As before, if the file is available, it is cached and provided to the CPU on a read-only basis.

As yet another option, the device processor may be programmed to monitor, control, and/or process user files written to the second designated storage section. Also, if the CPU is communicably connected to a network through the network interface of the storage device, the device processor may be programmed to monitor, control, and/or process network traffic passing through the network interface to and from the CPU.

As yet another option, the storage device may be programmed to copy user files stored within the second designated storage area, whether for backup or archive purposes, to the removable media storage component. Alternatively, or in addition, the storage device may be programmed to copy user files stored within the second designated storage area to one or more of file servers of a service provider if the service provider offers such as an optional data backup/archiving service.

As yet another option, the device processor may be adapted to delete a cached file from the storage means upon receiving a delete command for the cached file from one or more of the select file servers. Alternatively, the cached files may include a file expiration tag, with the device processor being adapted to delete a cached file according to criteria determined by the file expiration tag. Such tags may include an absolute time and date stamp, a relative time and date stamp, or some other non-time related criteria which serves as indicia for when the file should be deleted.

Accordingly, a secure PCS is disclosed. Advantages of the improvements will appear from the drawings and the description of the preferred embodiment.

### BRIEF DESCRIPTION OF THE DRAWINGS

In the drawings, wherein like reference numerals refer to similar components:

FIG. 1 is a schematic diagram of common components of a typical PCS according to the prior art (mainly, U.S. Pat. No. 7,321,783);

FIG. 2 is a schematic diagram of a PCS incorporating an anti-virus module of U.S. Pat. No. 7,654,941;

FIG. 3 is a schematic diagram of a first storage device found in the prior art;

FIG. 4 is a schematic diagram of a PCS incorporating the storage device of FIG. 3;

FIG. 5 is a schematic diagram of a second storage device found in the prior art;

FIG. 6 is a schematic diagram of a PCS partially incorporating the storage device of FIG. 5 to manage a few key components of the PCS;

FIG. 7 is a schematic diagram of a PCS fully incorporating the storage device of FIG. 5 to manage all components of the PCS; and

FIG. 8 is a schematic diagram of another PCS fully incorporating the storage device of FIG. 5.

### DETAILED DESCRIPTION OF THE PREFERRED EMBODIMENTS

For purposes of the present description, the term “non-user file” means a file that is a component of an operating system of a PCS, a component of an application, or a file that is designated as one to which a user should have read-only access. The term “user file” as used herein means a file that is not defined as a non-user file and is usually generated as a direct result of the user's use of the PCS. Such user files may include temporary files generated by the operating system or the applications for the benefit of the user. Under these definitions, the delineation between a non-user file and a user file is preferably determined by PCS and network administrators and/or service providers (hereinafter simply “administrators”) for any particular PCS and network. Thus, one skilled in the art will recognize that different administrators may elect to place the same file in different categories, i.e., the administrator of a first network may choose to treat a particular file as a non-user file, while the administrator of a second network may choose to treat the exact same file as a user file.

In addition, the term “server” encompasses both a computing device configured to operate as an independent server on a network and a “virtual server”, which effectively simulates the functionality of an independent server in software and enables multiple virtual servers to be hosted by a single networked computing device. While some virtual servers may only simulate the functionality necessary to perform the function of a server, other virtual servers may simulate part or all of the hardware components of a computing device in order to replicate the desired server functionality.

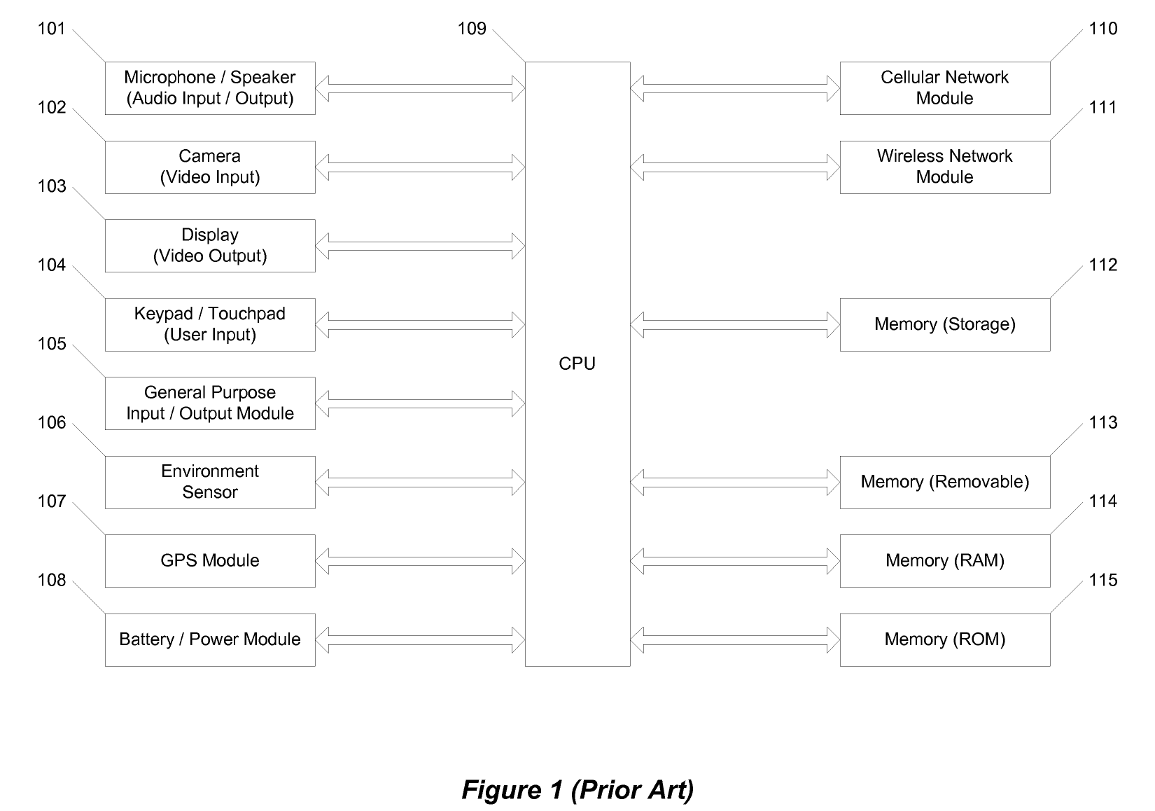

Turning in detail to the drawings, FIG. 1 is representative of common components of a typical PCS according to the prior art (mainly, U.S. Pat. No. 7,321,783). The PCS can be a PDA, a smart phone, or a hand-held gaming or entertainment device. Depending on the usage, the PCS can have all or some the components shown on the drawing: a CPU 109, memory 115 for BIOS or firmware, memory 114 for program execution, memories 112 and 113 for storing programs and data, microphone/speaker 101, camera 102, display 103, keypad/touchpad 104, general purpose input/output module 105, environmental sensor 106, GPS module 107, battery/power module 108, cellular network module 110, wireless network module 111, etc. Those skilled in the art will recognize that many options and choices are available for the components and will be able to incorporate any other components available today or in the future.

The CPU 109, loaded with an operating system, is responsible for managing the interaction between the components to form a functional PCS. In particular, the CPU 109 handles file requests that may originate from applications or from the operating system running on the PCS. These file requests arise when the applications or the operating system require access to a file which resides on either memories 112 and 113 that store programs and data. To handle the file requests, the CPU 109 is programmed with the characteristics of how the memories 112 and 113 store programs and data. As such, the CPU 109 is solely responsible for all files, both non-user files and user files, stored in the memories 112 and 113. It can add, modify, or delete files with full access rights. Thus, if the CPU 109 is compromised (i.e. the operating system is hacked, an application is infected with virus, or a malicious program is running in the background), then the functionality of the PCS is seriously compromised and sensitive data may be leaked to an unauthorized person(s).

As mentioned above, a PCS may use an anti-virus anti-spyware program to deter malicious programs (viruses and spyware). But as also mentioned above, use of an anti-virus anti-spyware program on a PCS is quite impractical because, among many other reasons, (a) anti-virus anti-spyware programs are operating system dependent, (b) there are many different operating systems for PCS's, so it is almost impossible to develop anti-virus anti-spyware programs for various brands and models of PCS's, (c) virus/spyware signature files are getting bigger as the number of viruses and spyware are growing, (d) the processors used in most PCS's are not quite powerful enough to perform continuous scan for viruses and spyware, and (e) anti-virus anti-spy programs may have false-positive and erroneously delete or quarantine important files used by the operating system or applications, making PCS's not functional.

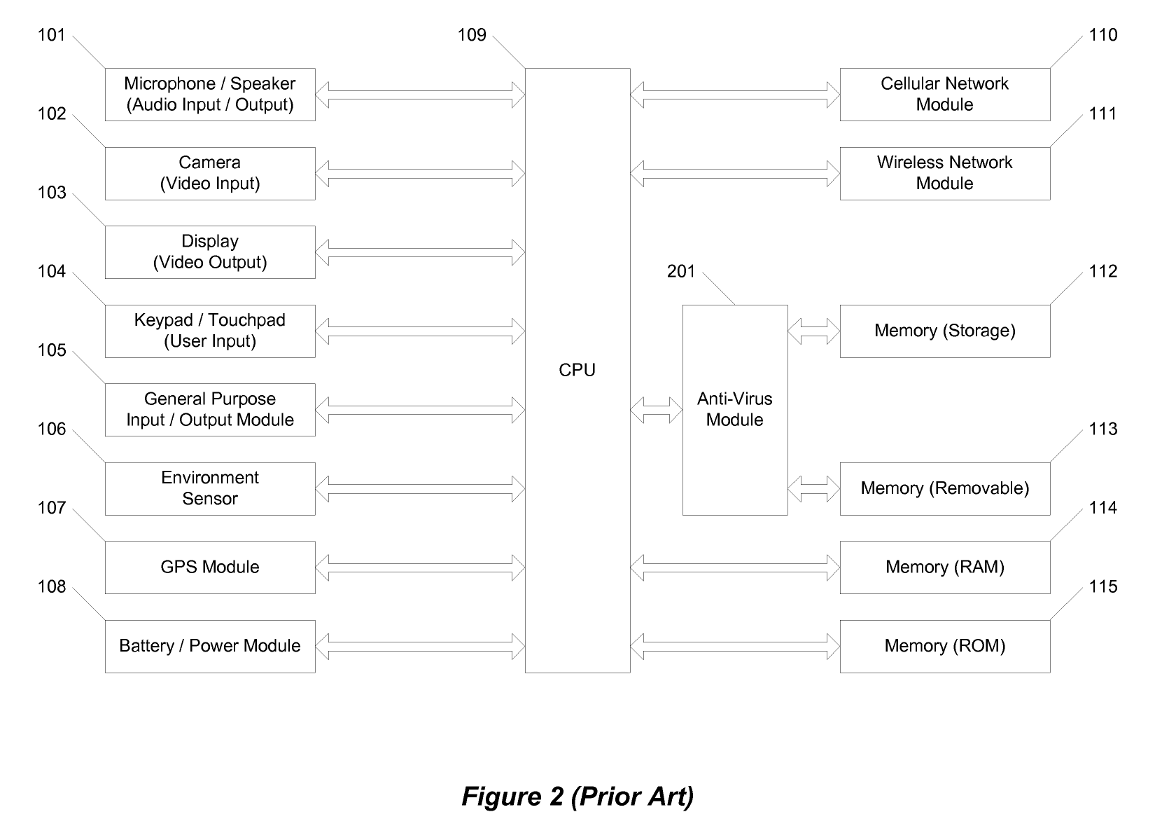

FIG. 2 illustrates a PCS incorporating an anti-virus module 201 of U.S. Pat. No. 7,654,941. The anti-virus module 201 off-loads the virus scanning task from the CPU 109; therefore, virus scanning can be performed independent of the CPU 109. Even if the CPU 109 is compromised or the operating system or applications running on the CPU 109 are compromised (i.e. the operating system is hacked, an application is infected with virus, or a malicious program is running in the background), the anti-virus module 201 can continuously scan for viruses and safeguard the files stored in the memories 112 and 113. However, obtaining updates to the scanning engine of the anti-virus module 201 or updates to virus/spyware signature files are dependent on the CPU 109. If the CPU 109 is compromised in such a way that prevents the anti-virus module 201 from obtaining updates, virus scanning may become antiquated and ineffective against new breeds of viruses and spywares. In addition, the anti-virus module 201 may have false-positive and erroneously delete or quarantine non-user files, making the PCS not functional. Furthermore, the anti-virus module 201 is not at all effective against file corruptions due to user errors or application errors, etc. A user or a process running with full access privileges can accidentally modify, delete, or corrupt non-user files and make the PCS not functional as well.

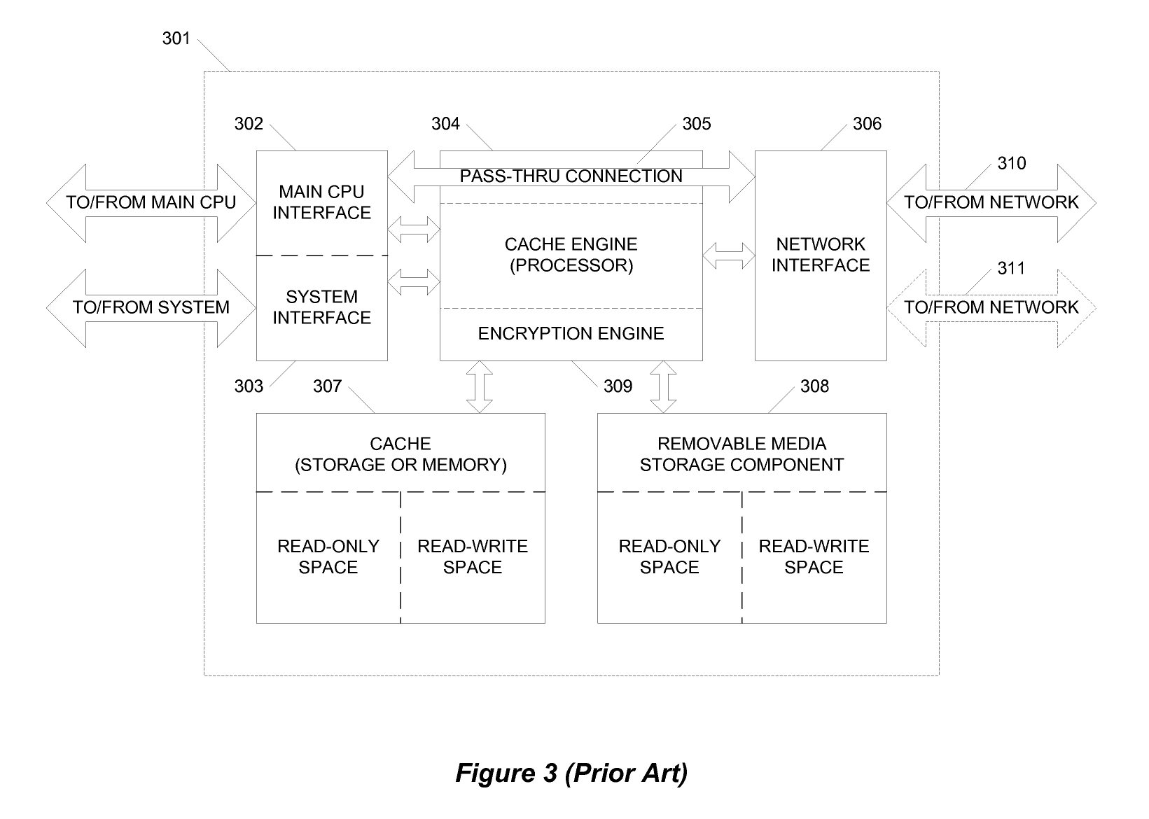

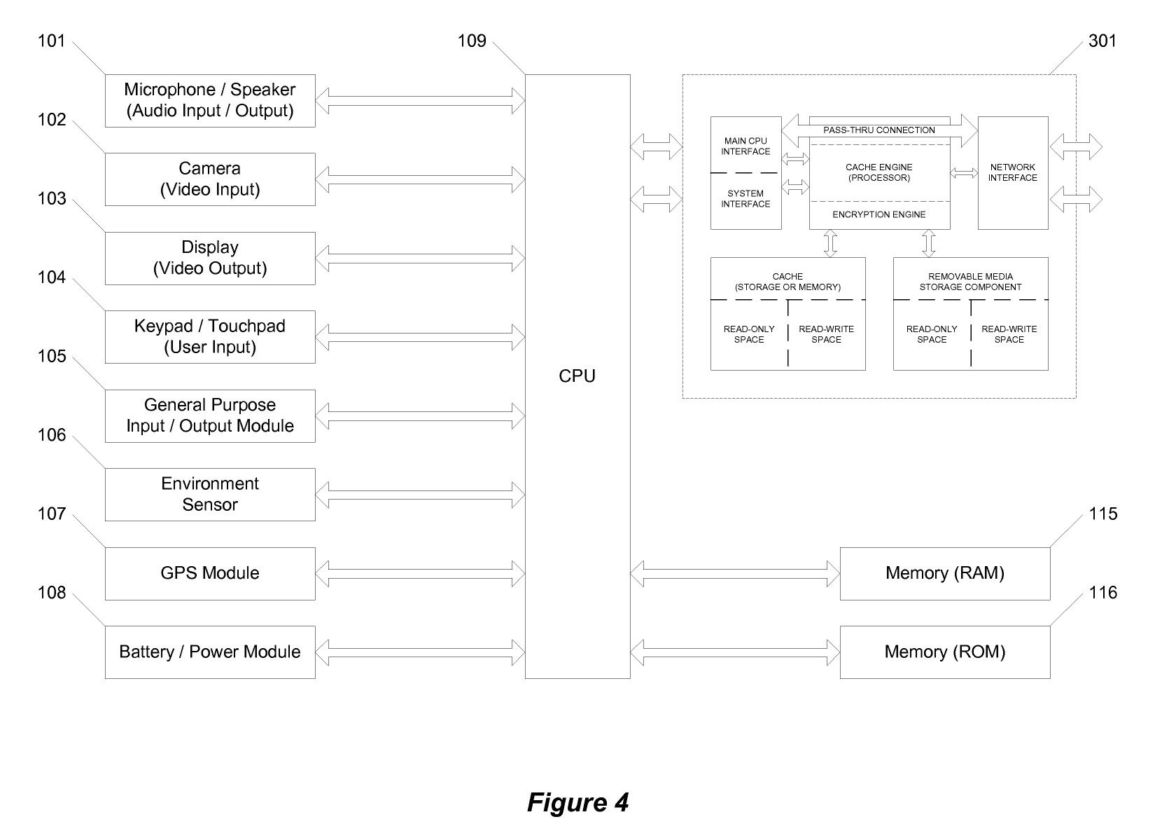

FIG. 3 illustrates a first storage device introduced in U.S. patent application Ser. No. 12/113,294, referenced by the related applications above, and its six basic components. The storage device 301 includes the device processor 304 (also referred to as the cache engine), the main CPU interface 302, the system interface 303, the network interface 306, the cache 307 (also referred to as the storage means), and the removable media storage component 308. The storage device 301 may be used in conjunction with a PCS, as shown in FIG. 4.

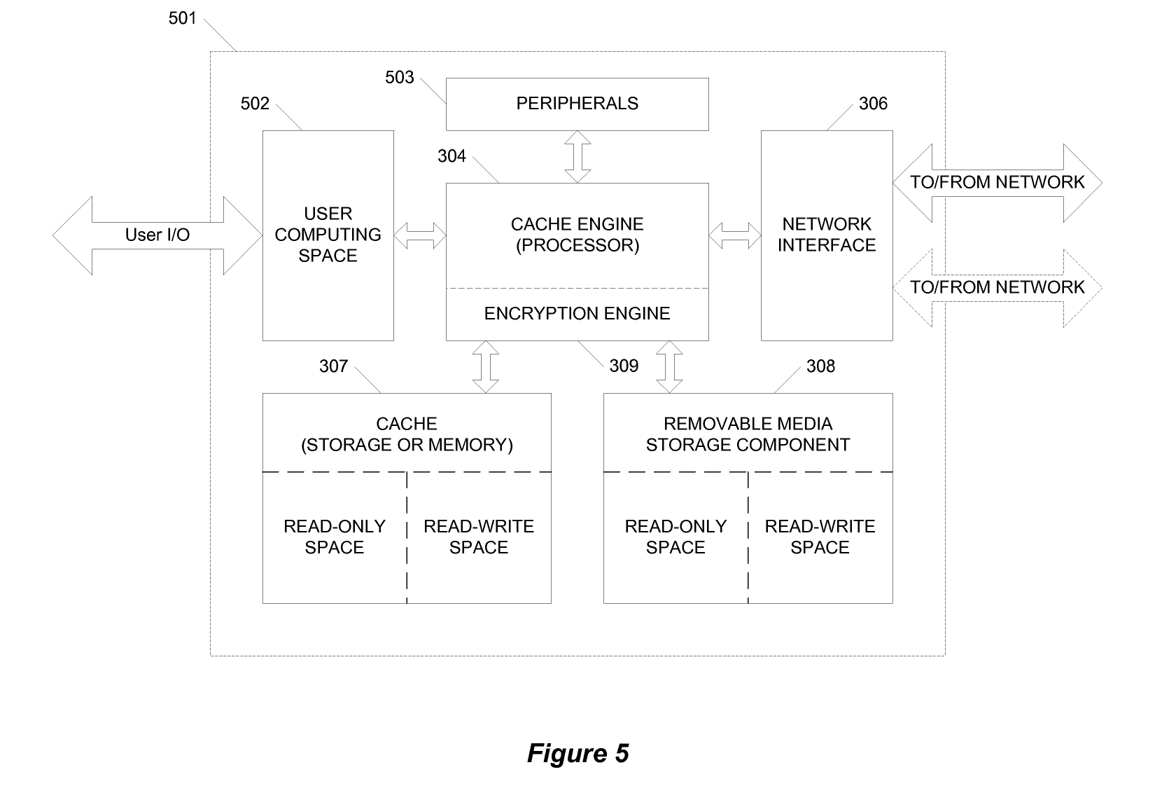

FIG. 5 illustrates a second storage device introduced in U.S. patent application Ser. No. 12/113,294, referenced by the related applications above. The storage device 501 has the user computing space 502 that is configured to interface with the CPU 109 of the PCS. The device processor 304 is configured to interface with the other peripherals 503 directly, and the storage device 501 is configured so that the CPU 109 of the PCS has access to the peripherals 503 only through the user computing space 502 and the device processor 304. Access to all other components of the storage device 501 is managed by the device processor 304 so that the CPU 109 of the PCS does not have direct access to files stored on the cache 307. Therefore, non-user files cached on the first designated storage section can be protected from malicious programs (viruses and spyware), user errors, or application errors. Even if there's a virus running on the CPU 109, there's no need to continuously scan for viruses on the first designated storage section since the virus can't infect (i.e. modify or alter) any of the non-user files or write itself to the first designated storage section. Furthermore, user files stored on the second designated storage section can be protected from unauthorized access even if the CPU 109 is compromised or the operating system or applications running on the CPU 109 are compromised (i.e. the operating system is hacked, an application is infected with virus, or a malicious program is running in the background). For instance, the device processor 304, which is independent of the CPU 109, can allow or disallow access to the user files, encrypt/decrypt the user files, or completely erase any or all user files to prevent unauthorized access (i.e. hackers trying to forcefully access sensitive data).

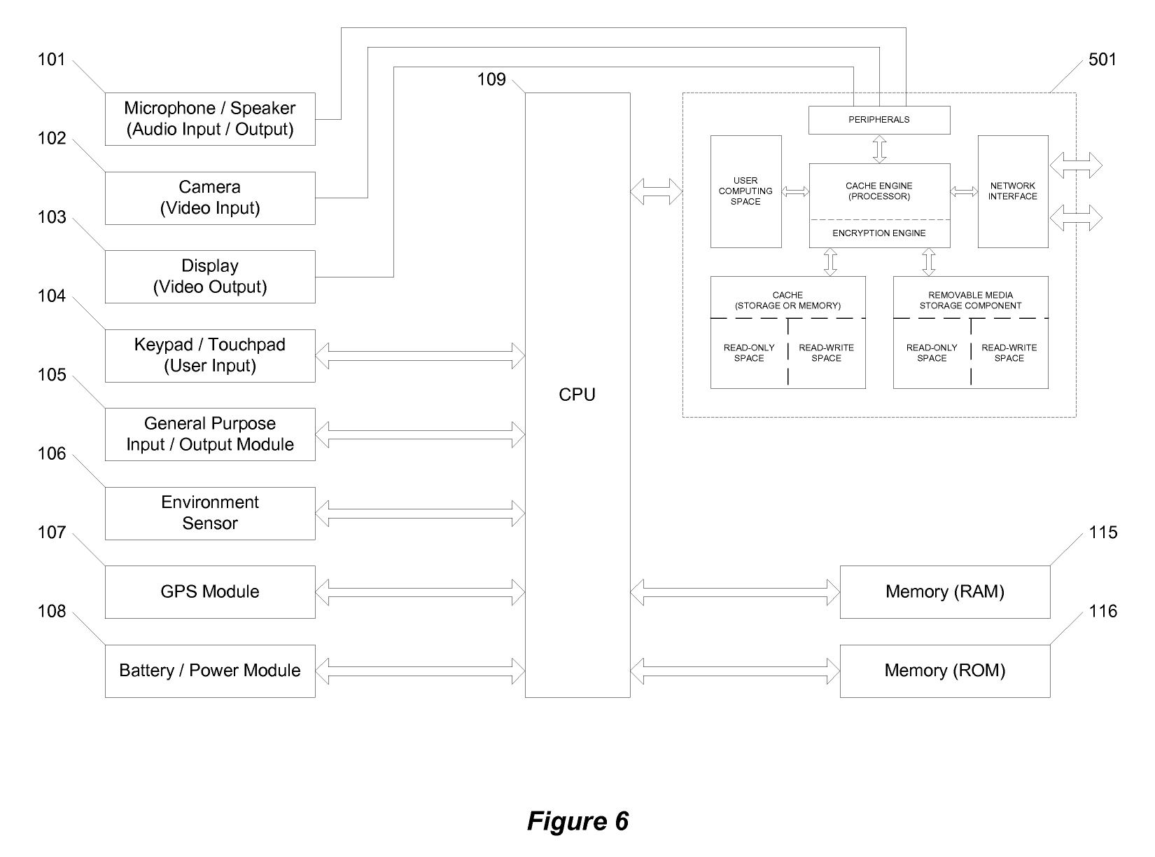

FIG. 6 illustrates a PCS that incorporates the storage device of FIG. 5 to manage a few key components, namely the audio input/output 101, the video input 102, and the video output 103 of the PCS.

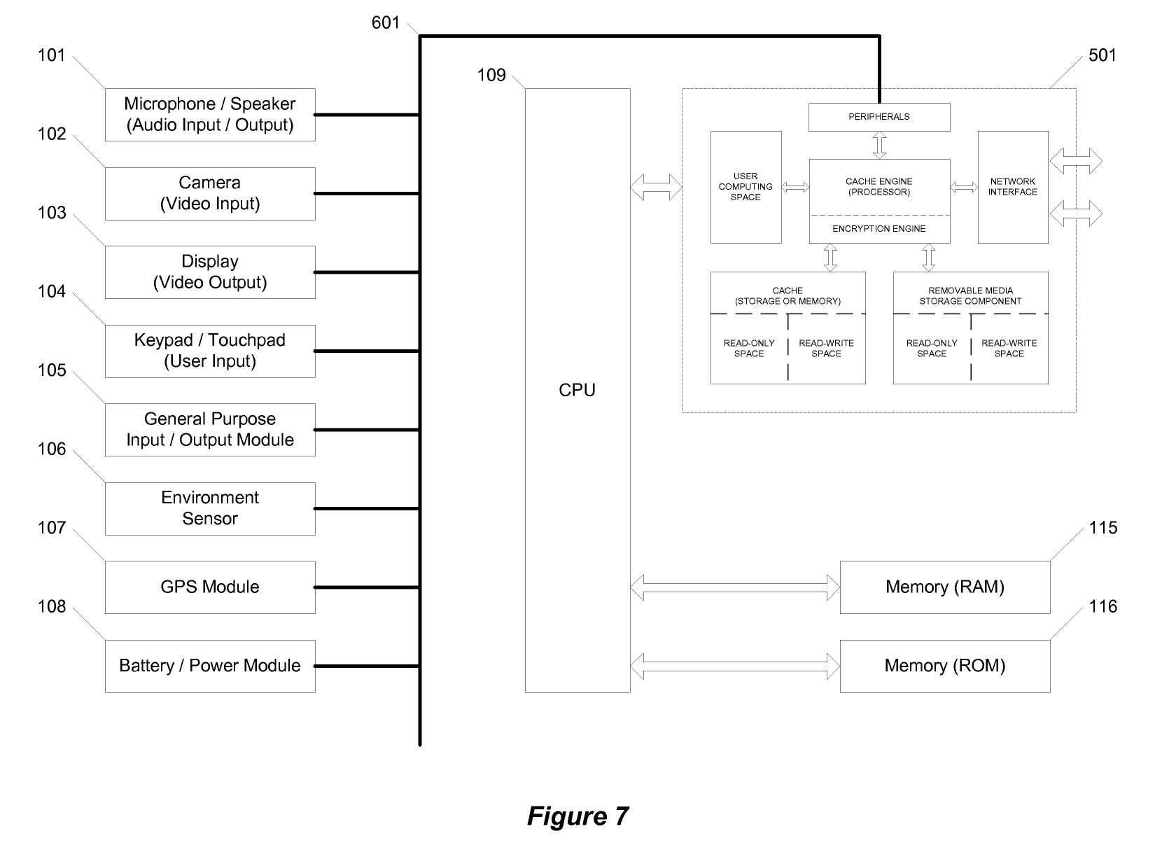

FIG. 7 illustrates a PCS that incorporates the storage device of FIG. 5 to manage all components of the PCS. These components include the audio input/output 101, the video input 102, the video output 103, the user input 104, a general purpose input/output module 105, an environment sensor 106, a GPS module 107, a batter/power module 108. Other modules with different functionality may be included as components in the PCS and controlled by the storage device.

FIG. 8 illustrates a PCS that incorporates the storage device of FIG. 5 one of whose network interfaces is adapted as a host connection 801 to a host computing device 802. The host computing device is configured to emulate a select file server by establishing an authoritative pairing relationship with the storage device, where the authoritative paring relationship can be established in many ways (i.e. by using device ID's, passwords, security certificates, or by an administrator on a select file server on the network).

The storage device 301 or 501 described herein is independent of the operating system of the PCS and is not constricted by having to conform to any particular protocols or file structures. The operating system of the PCS interacting with the storage device 301 or 501 needs to be programmed only with the protocol needed to request files stored on the storage device 301 or 501 or to access the peripherals of the storage device 501. Advantageously, communications between the CPU 109 of the PCS and the storage devices 301 or 501 may be performed using a small number of procedures. These procedures would be the only ones dependent on the operating system and system architecture of the PCS, and they can be standardized on any PCS platform.

Thus, a secure PCS having a storage device that has separate read-only space and read-write space, removable media component, system management interface, and network interface is disclosed. While embodiments of this invention have been shown and described, it would be apparent to those skilled in the art that many more modifications are possible without departing from the inventive concepts herein. The invention, therefore, is not to be restricted, except in the spirit of the following claims.

What is claimed is:

1. A personal communication system (PCS) comprising:
a central processing unit (CPU);
a plurality of hardware components, including one or more of a microphone and/or a speaker for audio input and/or output, a camera for video input, a display for video output, a keyboard and/or a touchpad for user input, a general purpose input/output module, a GPS module, a battery and/or a power module, a memory (RAM) for program execution, and a memory (ROM) for storing firmware; and
a secure storage device comprising:
a device processor;
a CPU interface communicably connected to the device processor, wherein the CPU interface is adapted to enable communications exclusively between the CPU and the device processor;
a system interface communicably connecting the device processor to the PCS, wherein the system interface is adapted to enable the device processor to manage one or more hardware components of the PCS;
a network interface communicably connected to the device processor, wherein the network interface is adapted to enable the device processor to communicate over a network, and the device processor is adapted to employ the network interface for communications with select file servers to the exclusion of other file servers;
a storage means communicably connected to the device processor, the storage means having a first designated storage section and a second designated storage section, wherein the device processor has read and write access to both the first and second designated storage sections, and the CPU has read-only access to the first designated storage section and read-write access to the second designated storage section;
a removable media storage component communicably connected to the processor.

2. The PCS of claim 1, the secure storage device further comprising an encryption module, wherein the device processor is adapted to utilize the encryption module for at least one of:
encrypted communication with the select file servers;
encrypted storage of files on the storage means; and
encrypted storage of files using the removable media storage component.

3. The PCS of claim 2, wherein the device processor is adapted to encrypt and decrypt files stored on the storage means using the encryption module and one or more encryption keys obtained from one of the select file servers.

4. The PCS of claim 1, wherein upon receipt of a request from the CPU for a non-user file, the device processor is adapted to sequentially (1) determine whether the file is cached within the first designated storage section and provide the file to the CPU on a read-only basis if the file is cached within the first designated storage section, (2) request the file from one or more of the select file servers if the file is not cached within the first designated storage section, and if the file is obtainable from one of the select file servers, cache the obtained file within the first designated storage section and provide the obtained file to the CPU on a read-only basis, and (3) return a file unavailable notice to the CPU if the file is not cached within the first designated storage section and not otherwise obtainable.

5. The PCS of claim 4, wherein after step (2) and before step (3), the device processor is adapted to determine whether the file is available from the removable media storage component, and if the file is available from the removable media storage component, obtain the file from the removable media storage component, cache the file within the first designated storage section, and provide the obtained file to the CPU on a read-only basis.

6. The PCS of claim 1, wherein upon receipt of a request from the CPU for a user file, the device processor is adapted to provide the CPU with read-write access to the second designated storage section.

7. The PCS of claim 1, wherein the device processor is adapted to perform one or more of monitoring, controlling, and processing all user files written to or read from the second designated storage section.

8. The PCS of claim 1, wherein the CPU is communicably connected to a network through the network interface and the device processor is adapted to perform one or more of monitoring, controlling, and processing network traffic passing through the network interface to and from the CPU.

9. The PCS of claim 8, wherein the device processor is further adapted to encrypt or decrypt of network traffic passing through the network interface to and from the CPU.

10. The PCS of claim 8, wherein the device processor is further adapted to allow or disallow network traffic passing through the network interface to and from the CPU according to preestablished rules.

11. The PCS of claim 1, wherein the storage means comprises random access media.

12. The PCS of claim 1, wherein the first designated storage section comprises contiguous address space within the random access media.

13. The PCS of claim 1, wherein the second designated storage section is not directly accessible by software running on the CPU.

14. The PCS of claim 1, wherein the device processor is adapted to delete a cached file from the storage means upon receiving a delete command for the cached file from one of the select file servers.

15. The PCS of claim 1, wherein the device processor is adapted to delete a cached file from the storage means following a period determined by a file expiration tag associated with the cached file.

16. The PCS of claim 15, wherein the period is defined by a time and date stamp included as part of the file expiration tag.

17. The PCS of claim 1, wherein the device processor is adapted to copy user files stored within the second designated storage area to one or more of the select file servers.

18. The PCS of claim 1, wherein the device processor is adapted to archive user files within the second designated storage area to the removable media storage component.

19. The PCS of claim 1, wherein the device processor is adapted to communicate with a host computing device over a host connection.

20. The PCS of claim 19, wherein the device processor is adapted to determine whether the secure storage device and the host computing device have an authoritative pairing relationship.

21. The PCS of claim 20, wherein, if the secure storage device and the host computing device have an authoritative pairing relationship, the device processor is adapted to sequentially (1) obtain lists of non-user files and/or user files available from the host computing device, (2) requests the non-user files and/or the user files on the lists from the host computing device, and (3) caches the non-users files within the first designated storage section and/or the user files within the second designated storage section.

22. The PCS of claim 20, wherein, if the secure storage device and the host computing device do not have an authoritative pairing relationship, the device processor is adapted to (1) execute a prescribed process to establish/reestablish an authoritative pairing relationship, (2) block any communication with the host computing device, (3) erase files cached in the first designated storage section and/or in the second designated storage section, and/or (4) disable any or all of its components temporarily or permanently.
